(19) United States
(12) Patent Application Publication
(10) Pub. No.: US 2012/0331540 A1
(43) Pub. Date: Dec. 27, 2012

(54) Authentication and authorization method for tasking in profile-based data collection

(75) Inventors: GEORGE E. HOFFMAN, SAN JOSE, CA (US); BRUCE BLAINE LACEY, FOSTER CITY, CA (US)

(73) Assignee: CARRIER IQ, INC., MOUNTAIN VIEW, CA (US)

(21) Appl. No.: 13/267,849

(22) Filed: Oct. 6, 2011

Related U.S. Application Data
(60) Provisional application No. 61/501,629, filed on Jun. 27, 2011.

(51) Int. Cl. H04L 9/32

(52) U.S. Cl. 726/10

(57) ABSTRACT

An apparatus and a new method of authentication and authorization of tasking requests to data collection agents on wireless devices directly makes use of public key cryptography, rather than depending on domain-name-based authenticated using the standard HTTPS chain-of-trust: A set of digital credentials is stored in the device's secure credential store. These credentials include at least one “supertasking authority” credential, as well as one or more normal “tasking authority” credentials. Profiles are only accepted by the agent if they are signed by a trusted tasking authority credential. Supertasking authority credentials thus serve as credential authorities (CAs) for tasking authority credentials.

### RELATED APPLICATIONS

Ser. No. 11/175,857 filed 5 Jul. 2005 issued as U.S. Pat. No. 7,609,650 on Oct. 27, 2009 discloses data collection agents and data collection profiles. Other related applications with common assignee include: Ser. Nos. 11/117,5572, 12/346,370, 12/371,190, 12/371,204, 12/849,800, and 13/043,347. A co-pending patent application Multi-party reporting in profile-based data collection Ser. No. 13/245,860 was filed 27 Sep. 2011. This application claims priority from PPA 61/501,629.

### BACKGROUND

1. Field of the Invention

The present invention relates generally to recording network and device parameters on wireless devices and related systems. More particularly, exemplary embodiments of the invention concern systems and methods for using distributed wireless devices to collect information about communication networks and user interaction with applications and services of wireless devices.

2. Related Technology

Profile-based data collection (as described by U.S. Pat. Nos. 7,551,922, 7,609,650, 7,865,194) provides enormous flexibility in gathering and processing data sourced from mobile devices. This flexibility, however, introduces the risk of benign or malignant misuse, which demands that robust security and authorization model govern the authority to task devices with new profiles and control their reporting rules. This problem is compounded by the presence of multiple tasking authorities (as described by co-pending patent application Ser. No. 13/245,860 filed 27 Sep. 2011 Multi-party reporting in profile-based data collection).

The existing method for authorization of tasking authorities uses a hard-coded “white list” of domain names which are permitted to perform tasking, verified via HTTPS using the standard chain-of-trust model to authenticate the domain against the device's root certificates. This method, while simple and secure, has several undesirable limitations:

Tasking authorities are often tied to the domain name from which the agent receives profiles and to which it reports data. This makes it difficult to model and enforce security rules in environments which may force the device agent to report in to only a single domain name but in which there may be multiple tasking authorities. This problem with a “single domain, multiple authorities” scenario makes it impossible for a “profile broker” to provide central tasking, profile auditing and quality control, instead forcing each authority to perform its own tasking and establish its own hosting environment for vending profiles. Finally, without some additional mechanism this method does not present a clear way to throttle the number of tasking authorities that can task a device simultaneously, or whether a single authority could task a device multiple times.

In conventional systems, there is no way to authorize additional tasking authorities after the device has shipped, without an expensive software update, because the only way to allow new authorities is to add them to the hard-code white list. If the potentially valid tasking authorities for a given device are not known at the time of device manufacture, this makes it difficult or impossible for those authorities to receive any value from the agent. For example, if an unlocked device is sold by an OEM and then attached to a network by the user, the operator of that network may wish to understand how its network performs and interoperates with respect to that device's hardware and software. The current hard-coding of tasking authorities makes this difficult. It also prevents value-added service providers (such as audience measurement or competitive analysis benchmarking firms) from establishing mutually-beneficial relationships with consumers and making use of the presence of the agent on the device for their own purposes.

An additional problem is that this method is entirely hidden from the user, such that the user does not have any way to determine what authorities are collecting data from their devices, and to opt-in or out of collection for various purposes. Unfortunately, this requires that a priori agreements (such as a Terms Of Use contract) be in place with any potential tasking entities (at the time the device ships) in order to enforce legal and ethical use of the solution. What is needed is a more transparent and dynamic way to ensure privacy and control data collection.

### SUMMARY OF AN EXEMPLARY EMBODIMENT OF THE INVENTION

One aspect of the invention is a new method of authentication and authorization of tasking requests which directly makes use of public key cryptography, rather than depending on domain-name-based authenticated using the standard HTTPS chain-of-trust:

The agent maintains at least one digital credential (ideally stored safely in the device's secure credential store.) These credentials may include at least one “supertasking authority” credential, and in embodiments one or more normal “tasking authority” credentials.

All profiles are signed by a tasking authority credential. Profiles are only accepted by the agent if they are signed by a trusted tasking authority credential. Any (non-super) tasking authority credential must be signed by a known supertasking authority credential in order to be considered trusted. Supertasking authority credentials thus serve as credential authorities (CAs) for tasking authority credentials.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic of a system in which the invention operates;

FIG. 2-4 are a block diagrams of apparatus embodiments; and

FIG. 5-7 are method flow charts for controlling a processor.

### DETAILED DESCRIPTION OF EMBODIMENTS OF THE INVENTION

One aspect of the invention is a method for operating a data collection agent on a wireless device which utilizes a credential such as a public key of a public/private key pair. In an embodiment, cryptographic certificates. Each data collection tasking profile is only accepted if signed by a trusted tasking authority credential. Such a credential need not implement all of the capabilities expected of a full SSL certificate in order to minimize impact on the performance of its wireless device platform.

Supertasking authority credentials can be installed in a device at manufacture time or by a secure system software update, and each supertasking credential of one of two types:

A silent supertasking credential allows any tasking credential signed by it to be obeyed without asking the user for permission. This is for use by multiple tasking authorities all working within the same agreement or legal arrangement (for example, multiple business units within the same mobile operator, or multiple companies partnered and working under the umbrella of one of those company's Terms Of Use agreement with the customer.)

A noisy supertasking credential requires that the user explicitly agree to their device being tasked by the authority in question. In this case, the tasking authority credential must contain information about the company or other entity requesting the data collection, to be shown to the user at the time the initial tasking request is processed.

Tasking authority credentials can be provided to the device along with the tasking request (i.e. profile) as part of the same transaction. In the case that a previously unknown credential is provided in this way, the device will first attempt to establish acceptance of the new tasking credential before attempting to validate the profile. In the case that the tasking credential is signed by a trusted silent supertasking credential, the device will simply verify the chain of trust and accept the credential (and subsequently the profile) silently, with no user interaction. In the case that the tasking credential is signed with a noisy supertasking credential, the user will be asked for permission as to whether the new tasking authority should be granted permission to collect information. In an embodiment the issuer of a supertasking authority credential may verify that a proposed profile follows the terms of use or privacy agreement or is limited to the user's intention to support data collection goals.

Once a tasking credential is accepted (via silent or noisy methods), any new profiles signed with that credential will be permitted silently. The agent may keep a list of explicitly (noisily) authorized tasking authorities for later inspection and potential revocation by the user.

As a potential extension, each tasking authority credential may contain a set of rules that defines what the credential permits profiles to do. In a trivial case, these rules might include the set of metric IDs that can be collected using profiles signed with that credential. The agent can then validate any new profile with respect to those rules before accepting it, and/or enforce those rules at runtime (for example, never allowing profiles to even see metrics not meeting the given criteria.) These rules can also be provided to the user as part of the explicit “noisy” tasking authorization, to allow the user to inspect what information is being requested by a particular tasking authority.

The Agent enables multiple parties to provision (“task”) and maintain profiles on a single device, effectively allowing each tasking authority to talk to its own “virtual” agent which solely serves its needs. The agent is responsible for maintaining and executing these multiple profiles and their associated collected data, and for reporting up to each of the tasking authorities on the schedule they specify. This behavior is transparent to both on-device clients of the agent and to tasking authorities. The agent still receives a single stream of metrics from the system, and performs profile-specific filtering and processing on those metrics for each profile being obeyed at any given time. A supertasking credential may include priorities to resolve conflicts between profiles for resources.

One aspect of the invention is a method for operation of a data collection agent on a wireless device comprises:
receiving a signed data collection tasking profile;
reading a trusted tasking authority credential;
installing the signed data collection tasking profile after verifying the signature by the trusted tasking authority credential, and
executing the instructions contained within the verified signed data collection tasking profile.

In an embodiment, the trusted tasking authority credential is a supertasking authority.

In an embodiment, the trusted tasking authority credential is not issued by a supertasking authority but is signed by a supertasking authority.

In an embodiment, the method further comprises reading a supertasking authority credential which was installed in the device's secure credential store at manufacture time or by a secure system software update.

In an embodiment, the method further comprises discarding a data collection tasking profile which is not signed by a trusted tasking authority credential.

In an embodiment, the method further comprises receiving a tasking authority credential, verifying it is signed by a supertasking authority and storing it into trusted tasking credential store.

In an embodiment, a credential makes use of public key cryptography.

In an embodiment, the supertasking credential is a noisy supertasking credential and the method further comprises:
displaying to the user information contained within the noisy supertasking credential, and
discarding the tasking profile when the user does not agree to the data collection, and
executing the tasking profile when the user explicitly agrees to the data collection.

In an embodiment, the information contained within the noisy supertasking credential is the identity of the company or entity requesting collection and transmittal of the data collection.

In an embodiment, the method further comprises displaying to the user the metrics the tasking profile proposes to collect if approved.

In an embodiment, a supertasking credential is a silent supertasking credential and the method further comprises installing and executing a tasking profile without asking the user for permission.

In an embodiment, the method further comprises:
keeping a list of explicitly authorized tasking authorities,
displaying on demand a selectible list of explicitly authorized tasking authorities enabling selected revocation, and
accepting any new profiles signed with a credential on the list of explicitly authorized tasking authorities without displaying information in the credential for approval.

In an embodiment, the method further comprises reading within a tasking authority credential a set of rules that defines what the credential permits profiles to do and validating any new profile with respect to those rules before accepting it, and/or enforce those rules at runtime.

Reference will now be made to the drawings to describe various aspects of exemplary embodiments of the invention. It should be understood that the drawings are diagrammatic and schematic representations of such embodiments and, accordingly, are not limiting of the scope of the present invention, nor are the drawings necessarily drawn to scale.

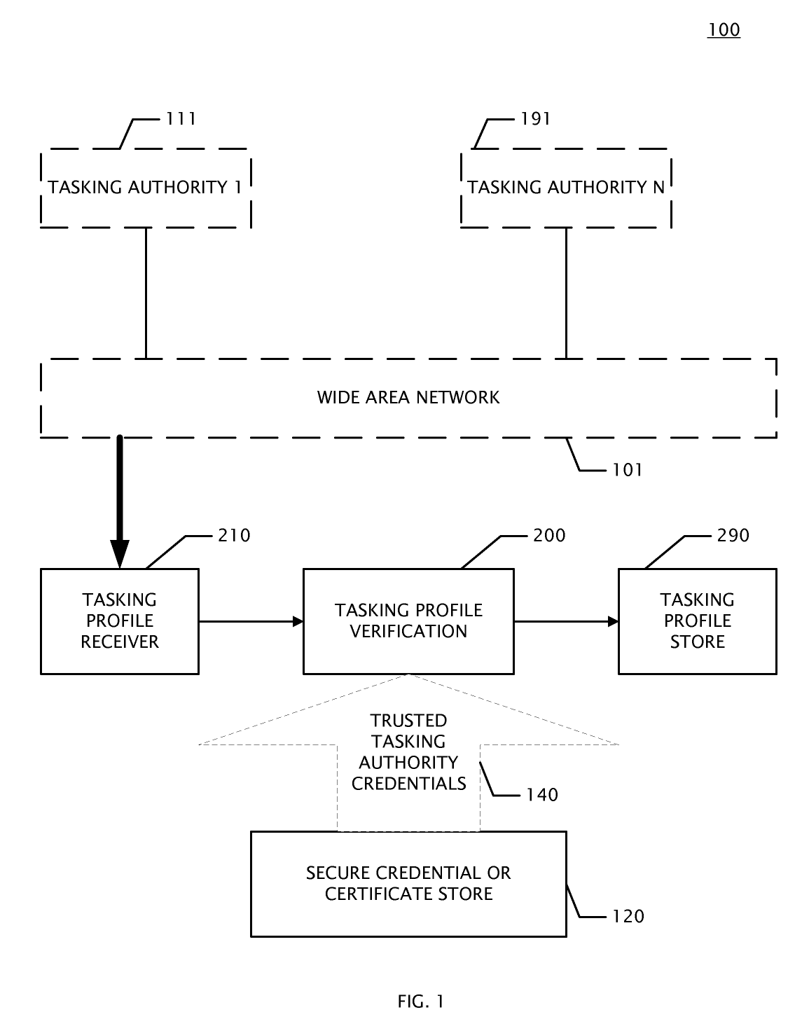

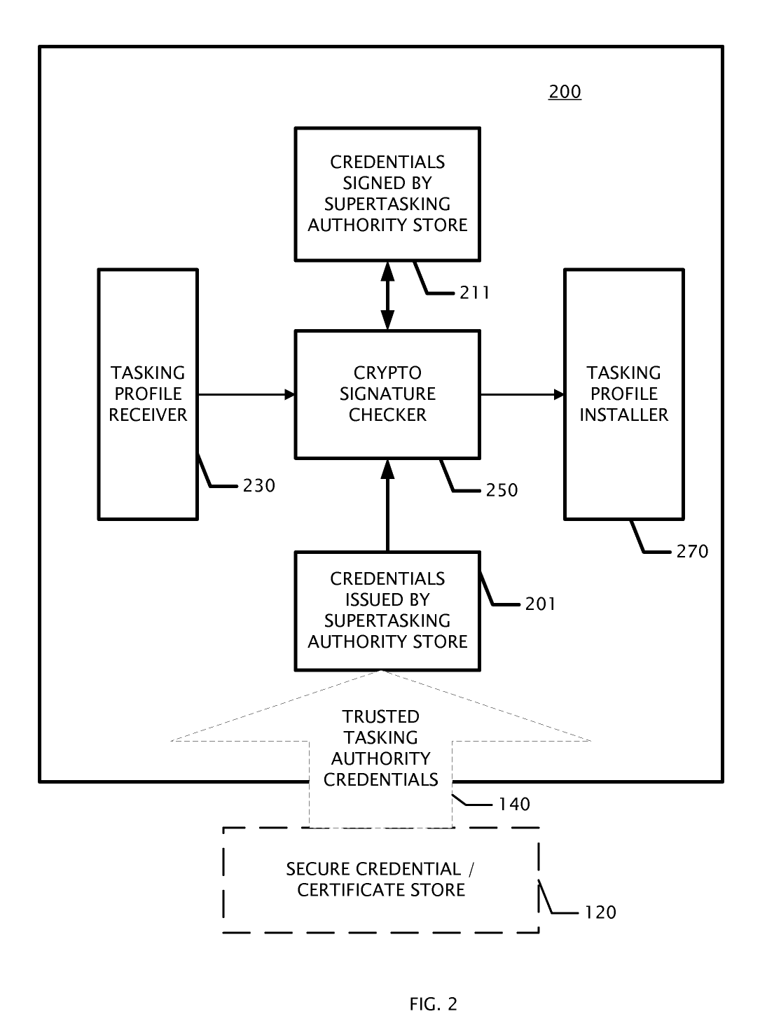

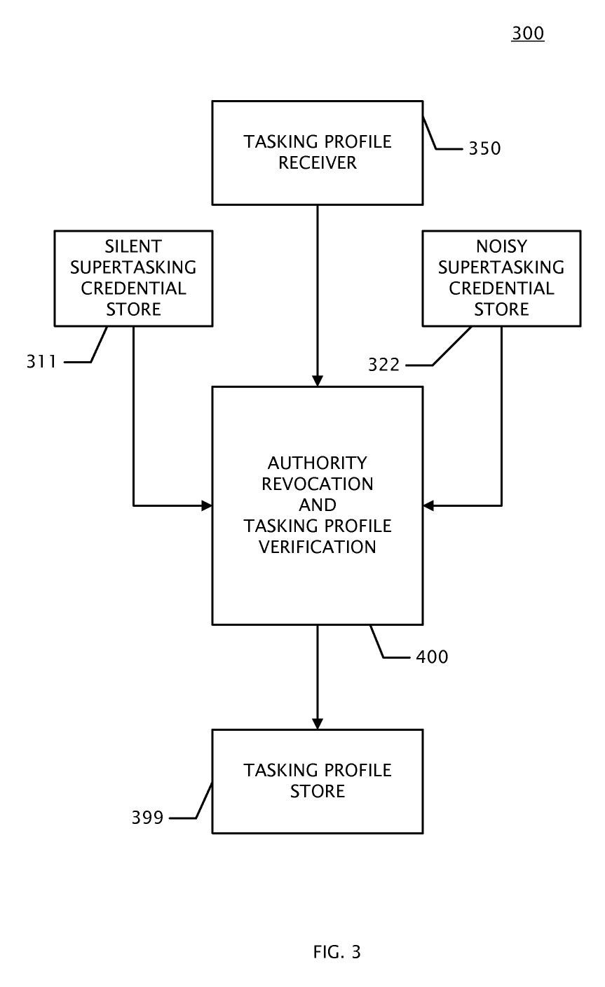

FIG. 1 is a schematic of a system in which the invention operates. A plurality of tasking authorities 111-191 is coupled through a wide area network 101 such as the Internet to a tasking profile receiver 210. The tasking profile receiver is communicatively coupled to a tasking profile verification circuit 200. A secure credential store 120 is also communicatively coupled to the tasking profile verification circuit 200 and provides at least one trusted tasking authority credential 140. When a tasking profile is verified using a trusted tasking authority credential, the tasking profile verification circuit stores it into a tasking profile store 290. In FIG. 2 is a block diagram of an embodiment of a tasking profile verification circuit 200. A crypto signature checker circuit 250 is coupled to a tasking profile receiver 230 to receive a tasking profile. The crypto signature checker is further coupled to a tasking profile installer circuit 270. In an embodiment the crypto signature circuit is further coupled to a store 201 which contains credentials issued by a supertasking authority. In an embodiment the crypto signature circuit is further coupled to a store 211 which contains credentials signed by a supertasking authority. The crypto signature checker stores a tasking profile into the tasking profile installer 270 when one or more of the credentials is successfully checked with a signature in a tasking profile. The crypto signature checker also checks if a credential is signed by a supertasking authority by using a credential issued by a supertasking authority. FIG. 3 is a block diagram illustrating an embodiment of the invention which provides a silent supertasking credential store 311 and a noisy supertasking credential store 322. A tasking profile is transferred from a tasking profile receiver circuit 350 to a tasking profile store 399 by a communicatively coupled authority revocation and tasking profile verification circuit 400. In an embodiment the authority revocation and tasking profile verification applies a silent supertasking credential to a tasking profile without user interaction. In an embodiment the authority revocation and tasking profile verification circuit requires user input when applying a noisy supertasking credential.

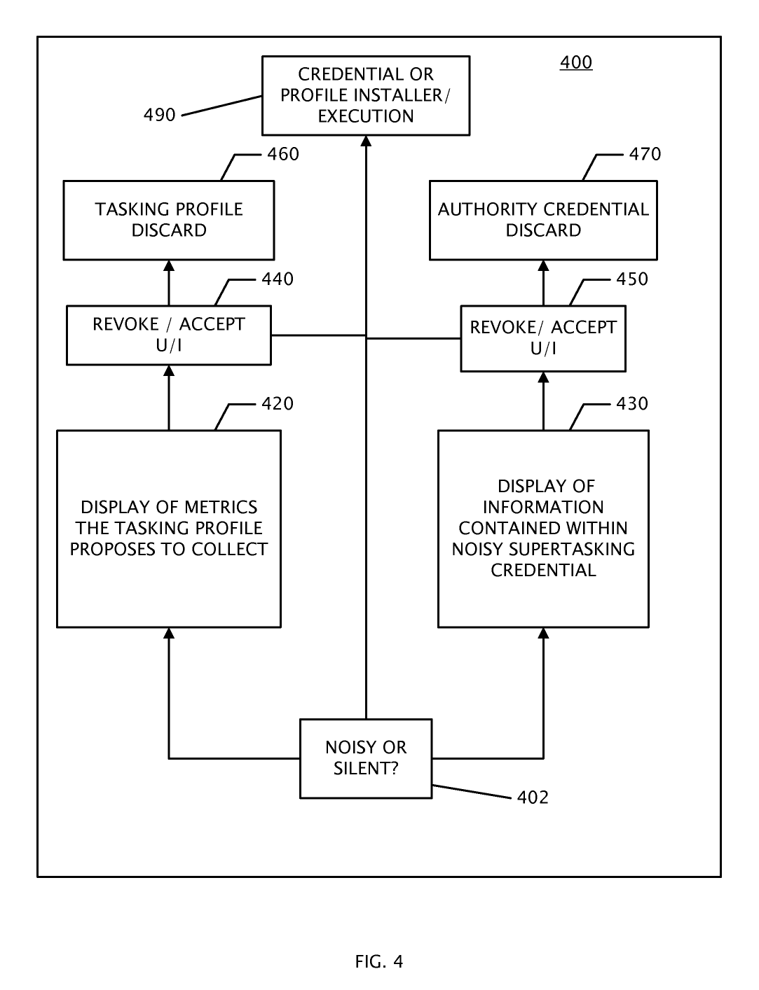

A block diagram in FIG. 4 illustrates an apparatus which stores or discards profiles and credentials. A noisy or silent determination circuit 402 analyzes a credential and directs control to a display and user interface if a credential is noisy. In one embodiment, a noisy supertasking credential contains information which provided to a display circuit 430. A user interface 450 allows a user to revoke or accept the credential. In one case the authority credential is transferred to a discard circuit 470. In the other case the authority credential is transferred to a credential installer 490. In an embodiment, a noisy credential controls a display 420 to show the user the metrics that a certain profile is configured to record and report. A user interface 440 allows the user to revoke or accept the tasking profile. In one case the tasking profile is provided to a discard circuit 460, and in the other case the tasking profile is provided to a profile installer 490.

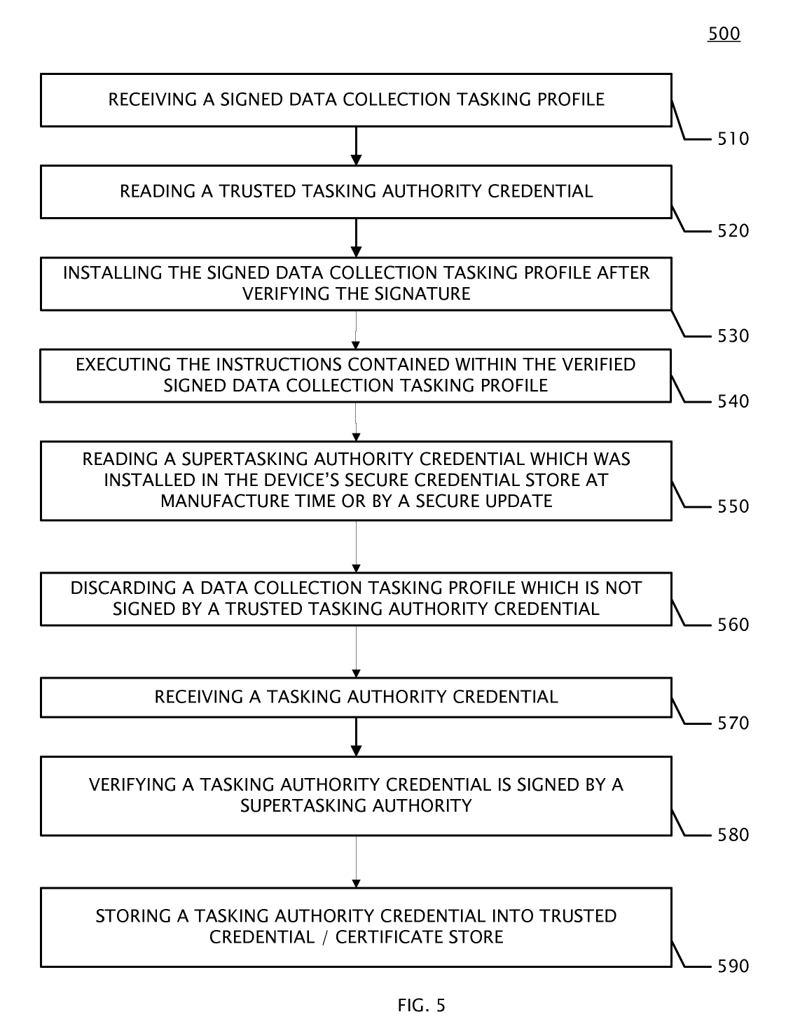

One aspect of the invention is a method as illustrated in FIG. 5 for operation of a data collection agent on a wireless device. The method comprises:
receiving a signed data collection tasking profile 510;
reading a trusted tasking authority credential 520;
installing the signed data collection tasking profile 530 after verifying the signature by the trusted tasking authority credential, and
executing the instructions contained within the verified signed data collection tasking profile 540.

In an embodiment the trusted tasking authority credential is a supertasking authority. In an embodiment the trusted tasking authority credential is not issued by a supertasking authority but is signed by a supertasking authority.

In an embodiment the method further comprises
reading a supertasking authority credential which was installed in the device's secure credential store at manufacture time or by a secure system software update 550. In an embodiment the method further comprises
discarding a data collection tasking profile which is not signed by a trusted tasking authority credential 560. In an embodiment the method further comprises
receiving a tasking authority credential 570,
verifying it is signed by a supertasking authority 580 and
storing it into trusted tasking credential store 590.

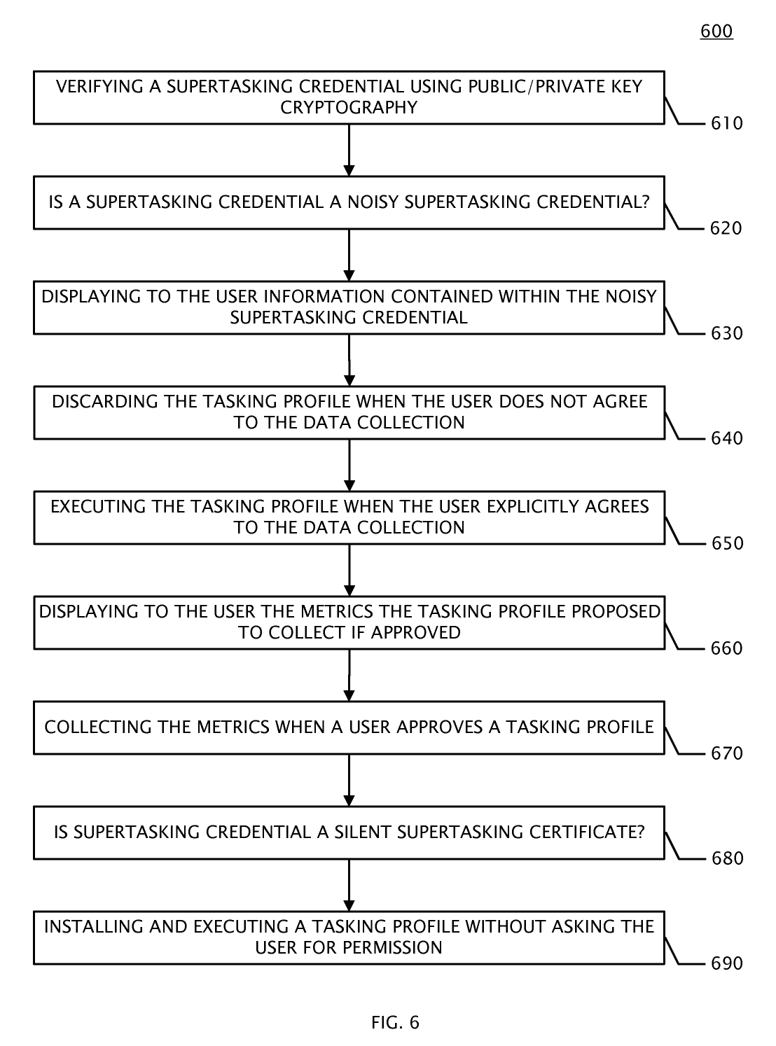

Referring now to FIG. 6, in an embodiment a credential makes use of public key cryptography which is used to verify a supertasking credential 610.

In an embodiment a supertasking credential is a noisy supertasking credential 620 and the method further comprises:
displaying to the user information contained within the noisy supertasking credential 630, and
discarding the tasking profile when the user does not agree to the data collection 640, and
executing the tasking profile when the user explicitly agrees to the data collection 650.

In an embodiment, information contained within the noisy supertasking credential is the identity of the company or entity requesting collection and transmittal of the data collection. In an embodiment the method further comprises
displaying to the user the metrics the tasking profile proposes to collect if approved 660 670.
In an embodiment, a supertasking credential is a silent supertasking credential 680 and the method further comprises
installing and executing a tasking profile without asking the user for permission 690.

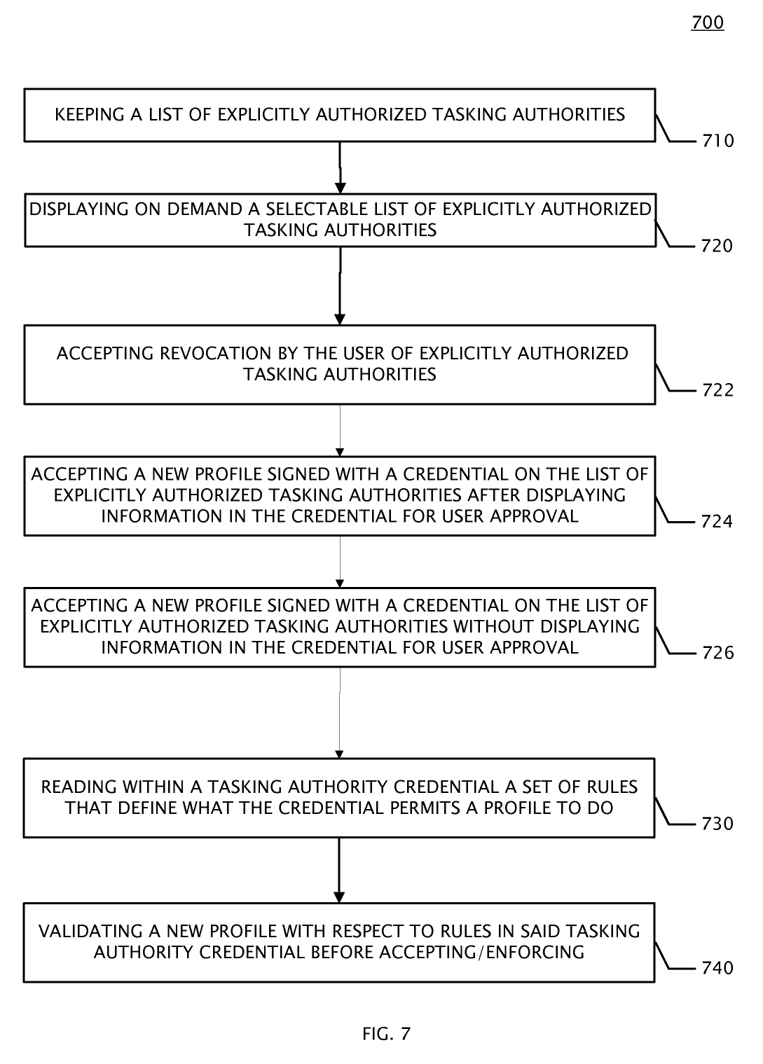

Referring now to FIG. 7, in an embodiment, the method further comprises
keeping a list of explicitly authorized tasking authorities 710,
displaying on demand a selectable list of explicitly authorized tasking authorities enabling selected revocation 720 722, and
accepting any new profiles signed with a credential on the list of explicitly authorized tasking authorities without displaying information in the credential for approval 724 726l.

In an embodiment, the method further comprises:
reading within a tasking authority credential a set of rules that defines what the credential permits profiles to do 730 and
validating any new profile with respect to those rules before accepting it, and/or enforce those rules at runtime 740.

The data collection profile may be, in one embodiment, a series of executable commands which may be executed by the data collection agent on the wireless device, the data collection profile defining a user survey and user inputs that are to be stored, and a condition under which the survey is to be launched and the inputs to be stored.

A data collection agent installed on a device executes survey study processes in response to “triggers” defined in the profile, which initiate and terminate survey study activities, as well as in response to other rules and instructions in the data collection profiles.

When received by a wireless device, the data collection profile is processed by the data collection agent. In some cases, the data collection profile may be stored as received, or integrated with or take the place of previously received data collection profile(s).

Rules in the data collection profile direct assignment of metrics to buffers and link triggers to generated metrics by matching the identifiers in the common aspects of the metrics data structure. Data collection profiles can be implemented that define survey rules, triggers and buffers for metrics requirements that arise after production and implementation of the agent.

In an embodiment, a profile comprises executable program instructions in binary code, in interpretive code, in procedural code, or in 4^{th} generation language to manipulate data and metrics at the adaptive agent. The executable instruction may compress metrics into packages, summarize a series of events or behaviors, recognize a pattern, monitor a state machine, trigger an upload, change a destination uniform resource identifier, initiate a new package, change a package definition, mask or unmask portions of a profile to enable or disable subscribing to a datastream, enable or disable recording of parameters or behaviors, maintain a rolling history of observations, events, records, send notifications of an event, compute or trace.

A profile includes a schedule or trigger for upload, a fallback for upload failure, a destination Uniform Resource Identifier (URI) and a plurality of device metrics and user inputs to assemble into at least one package. In an embodiment the profile contains program code to perform computations or thresholds to determine if an upload is enabled or disabled. Program code within a profile may alter the selection or transformation of metrics or sense a sequence of events which trigger a specialized set of procedures or launch a user interface. The program code within a profile may determine the appropriate combination of metrics for a condition or state.

Each individual profile controls what an agent records, combines a plurality of metrics and recordations into at least one package. In an embodiment a profile can determine a schedule for uploading a package. At a first step in filtering, an agent controlled by a profile may discard data which is not useful.

In an embodiment, credentials are SSL certificates complying with the Transport Level Security standard (TLS) an IETF standards track protocol, last updated in RFC 5246. In an embodiment credentials are signed by a Trusted Certificate Authority well known to those skilled in the art. In an embodiment credentials are tailored and optimized to the capabilities, capacities, and needs of wireless devices and may be self-signed.

In an embodiment, a credential may allow priority assignment to a profile when limited resources on a wireless device cannot fulfill all profile directives. In an embodiment, credential may report on all profiles installed on a particular wireless device.

An other aspect of the invention is an apparatus comprising:
a super-tasking credential store;
a profile store;
a processor configured to record, transform, and transmit metrics according to a profile read from the profile store; and
a cryptographic circuit to validate that a profile is signed by a credential read from the super-tasking credential store.

In an embodiment the apparatus further comprises: a receiver circuit to receive a plurality of profiles, at least one credential, and determine priority among the plurality of profiles.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the claims.

### CONCLUSION

The present invention can be distinguished from conventional systems that do not provide any verification, validation, authentication or check on authorization to collect data on a wireless device. The present invention can be distinguished from a conventional system that cannot report on multiple profiles which are resident on a wireless device. The present invention can be distinguished from a conventional system which is unable to resolve conflicts over resources among multiple profiles.

What is claimed is:

1. A method for operation of a data collection agent on a wireless device comprises:
receiving a signed data collection tasking profile;
reading a trusted tasking authority credential;
installing the signed data collection tasking profile after verifying the signature by the trusted tasking authority credential, and
executing the instructions contained within the verified signed data collection tasking profile.

2. The method of claim 1 wherein the trusted tasking authority credential is a supertasking authority.

3. The method of claim 1 wherein the trusted tasking authority credential is not issued by a supertasking authority but is signed by a supertasking authority.

4. The method of claim 1 further comprises
reading a supertasking authority credential which was installed in the device's secure credential store at manufacture time or by a secure system software update.

5. The method of claim 1 further comprises
discarding a data collection tasking profile which is not signed by a trusted tasking authority credential.

6. The method of claim 1 further comprises
receiving a tasking authority credential, verifying it is signed by a supertasking authority and storing it into trusted tasking credential store.

7. The method of claim 1 wherein a credential makes use of public key cryptography.

8. The method of claim 2 wherein a supertasking credential is a noisy supertasking credential and the method further comprises:
displaying to the user information contained within the noisy supertasking credential, and
discarding the tasking profile when the user does not agree to the data collection, and
executing the tasking profile when the user explicitly agrees to the data collection.

9. The method of claim 8 wherein information contained within the noisy supertasking credential is the identity of the company or entity requesting collection and transmittal of the data collection.

10. The method of claim 9 further comprising displaying to the user the metrics the tasking profile proposes to collect if approved.

11. The method of claim 2 wherein a supertasking credential is a silent supertasking credential and the method further comprises installing and executing a tasking profile without asking the user for permission.

12. The method of claim 10 further comprising
keeping a list of explicitly authorized tasking authorities,
displaying on demand a selectable list of explicitly authorized tasking authorities enabling selected revocation, and
accepting any new profiles signed with a credential on the list of explicitly authorized tasking authorities without displaying information in the credential for approval.

13. The method of claim 12 further comprising reading within a tasking authority credential a set of rules that defines what the credential permits profiles to do and validating any new profile with respect to those rules before accepting it, and/or enforce those rules at runtime.

14. The method of claim 13 further comprising applying priorities within a credential to resolve conflicts for resources from a plurality of profiles.

15. The method of claim 13 further comprising reporting on all the profiles which have been installed onto a wireless device.

16. The method of claim 1 wherein a credential is a SSL certificate.

17. The method of claim 16 wherein said SSL certificate is signed by a trusted Certificate Authority.

18. The method of claim 1 wherein a credential may be revoked.

19. An apparatus comprising:
a super-tasking credential store;
a profile store;
a processor configured to record, transform, and transmit metrics according to a profile read from the profile store; and
a cryptographic circuit to validate that a profile is signed by a credential read from the super-tasking credential store.

20. The apparatus of claim 19 further comprising: a receiver circuit to receive a plurality of profiles, at least one credential, and determine priority among the plurality of profiles.
